(19) United States
(12) Patent Application Publication
(10) Pub. No.: US 2026/0239424 A1
(43) Pub. Date: Aug. 13, 2026

(54) CHANNEL SWITCHING CONDITIONS FOR NON-PRIMARY CHANNEL ACCESS (NPCA)

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/434,737

(22) Filed: Dec. 29, 2025

Related U.S. Application Data
(60) Provisional application No. 63/758,108, filed on Feb. 13, 2025.

(51) Int. Cl. H04W 74/0816; H04W 28/02

(52) U.S. Cl. CPC H04W 74/0816; H04W 28/0268; H04W 28/0278

(57) ABSTRACT

Disclosed herein is a method performed by an access point (AP) operating a basic service set (BSS) to decide whether to perform non-primary channel access (NPCA) channel switching. The method includes responsive to detecting an overlapping basic service set (OBSS) transmission in a primary channel of the BSS, determining whether there is data to process between the AP and stations (STAs) associated with the AP and responsive to determining that there is data to process between the AP and the STAs, switching from the primary channel of the BSS to a NPCA primary channel of the BSS to perform the NPCA.

### CROSS-REFERENCE TO RELATED APPLICATION

This application claims the benefit of U.S. Provisional Application No. 63/758,108, filed February 13, 2025, titled “Framework for trigger condition decision in NPCA operation”, which is hereby incorporated by reference.

### TECHNICAL FIELD

The present disclosure generally relates to wireless communications, and more specifically, relates to channel switching conditions for non-primary channel access (NPCA).

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

According to existing IEEE 802.11 wireless networking standards, before a wireless device can transmit a physical layer protocol data unit (PPDU), the wireless device has to verify that the transmission bandwidth, including the primary channel, is idle. For example, consider a station (STA) having an operating bandwidth (OPBW) of 80MHz. The 80MHz operating bandwidth may include a primary 20MHz (P20) channel, a secondary 20MHz (S20) channel, and a secondary 40MHz (S40) channel. To transmit a 40MHz PPDU, both the P20 and S20 channels within the 80MHz operating bandwidth have to be idle. In a scenario where the P20 channel is busy but the S40 is idle, the STA is not allowed to transmit a 40MHz PPDU in the S40 channel (even though it is idle) due to an existing rule that transmission is not allowed when the primary channel is busy.

In IEEE 802.11bn (also referred to as ultra high reliability (or “UHR”)), with the increase in the operating bandwidth (e.g., to 320MHz), the traditional rule that prevents PPDU transmission when the primary channel is busy and the secondary channel is idle (e.g., P20 channel is busy and secondary 160MHz (S160) channel is idle) is seen as inefficient and wasteful of resources. The concept of non-primary channel access (NPCA) has been proposed to address this issue. With NPCA, transmission and reception can be performed in an idle non-primary channel (e.g., a secondary channel) even if the primary channel is busy. That is, even if the primary channel is busy, if there is a non-primary channel that is idle, NPCA allows transmission/reception in the idle non-primary channel.

Switching channels and performing NPCA can drain device power and cause interference. Thus, there is a need to define channel switching conditions for when a wireless device is allowed to switch channels to perform NPCA. The existing channel switching conditions allow a wireless device (e.g., an access point (AP) or non-AP station (STA)) to switch channels to perform NPCA when an overlapping basic service set (OBSS) transmission is detected in the primary channel and the OBSS transmission is expected to last longer than a minimum threshold duration. However, the existing channel switching conditions may be over-permissive in that they allow wireless devices to switch channels to perform NPCA even when it might not be beneficial to do so.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing the overcall concept of non-primary channel access (NPCA), according to some embodiments.

FIG. 11 is a diagram showing an example of performing NPCA after the sharing of traffic characteristic information among NPCA wireless devices, according to some embodiments.

FIG. 12 is a diagram showing an example of performing NPCA using the triggered channel access mode, according to some embodiments.

FIG. 13 is a diagram showing an example of performing NPCA using the triggered channel access mode and where all NPCA non-access point (non-AP) STAs perform NPCA channel switching without considering queued buffered data, according to some embodiments.

FIG. 14 is a diagram showing an example of performing NPCA using the untriggered channel access mode and where NPCA non-AP STAs decide whether to perform NPCA channel switching considering the buffered data in their own queues, according to some embodiments.

FIG. 15 is a flow diagram of a method for deciding whether to perform NPCA channel switching, according to some embodiments.

FIG. 16 is a flow diagram of a method for deciding whether to perform NPCA channel switching, according to some embodiments.

FIG. 17 is a flow diagram of a method for deciding which channel access mode to use when performing NPCA, according to some embodiments.

FIG. 18 is a flow diagram of a method for deciding whether to perform NPCA channel switching, according to some embodiments.

### DETAILED DESCRIPTION

The present disclosure generally relates to wireless communications, and more specifically, relates to channel switching conditions for non-primary channel access (NPCA).

As mentioned above, switching channels and performing NPCA can drain device power and cause interference. Thus, there is a need to define NPCA channel switching conditions for when a wireless device is allowed to switch channels to perform NPCA. The existing channel switching conditions allow a wireless device to switch channels to perform NPCA when an overlapping basic service set (OBSS) transmission is detected in the primary channel and the OBSS transmission is expected to last longer than a minimum threshold duration. However, the existing channel switching conditions may be over-permissive in that they allow wireless devices to switch channels to perform NPCA even when it might not be beneficial to do so.

The present disclosure introduces additional channel switching conditions for determining when to switch channels to perform NPCA. Applying the additional channel switching conditions may help avoid unnecessary channel switching and thus avoid unnecessary power drainage of devices.

According to some embodiments, when a NPCA-capable AP (which may be referred to herein simply as a NPCA AP) and NPCA-capable non-AP STAs (which may be referred to herein simply as NPCA non-AP STAs) associated with the NPCA-capable AP have access to traffic characteristic information (e.g., quality of service (QoS) information, stream classification service (SCS) information, and/or buffer status report (BSR) information) of each other’s traffic (e.g., traffic that the AP/STAs currently has buffered in their queues and/or traffic that the AP/STAs expect to transmit in the future (e.g., periodic traffic)), the NPCA AP and the NPCA non-AP STAs may determine whether to switch channels (from the primary channel to a non-primary/secondary channel) to perform NPCA based on the traffic characteristic information. For example, the NPCA AP and the NPCA non-AP STAs may switch channels to perform NPCA if the traffic characteristic information indicates that there is data to be processed between the NPCA AP and the NPCA non-AP STAs. However, if the traffic characteristic information indicates there is no data to be processed between the NPCA AP and the NPCA non-AP STAs, the NPCA AP and the NPCA non-AP STAs may remain on the primary channel (i.e., do not switch channels).

In an embodiment, the NPCA AP may perform NPCA in a triggered channel access mode or an untriggered channel access mode depending on the amount of downlink data that the NPCA AP has to process. For example, the NPCA AP may perform NPCA using the triggered channel access mode if it has a large amount of downlink data to process but perform NPCA using the untriggered channel access mode if it does not have a large amount of downlink data to process. The triggered channel access mode may be a mode in which the NPCA AP is allowed to initiate channel access in the NPCA primary channel but the NPCA non-AP STAs are not allowed to initiate channel access in the NPCA primary channel (i.e., the NPCA non-AP STAs can only transmit data after first being solicited by the NPCA AP). The untriggered channel access mode may be a mode in which both the NPCA AP and the NPCA non-AP STAs are allowed to initiate channel access in the NPCA primary channel. After the NPCA AP determines the channel access mode it will use to perform NPCA, it may transmit an indication of this channel access mode to the NPCA non-AP STAs. The NPCA non-AP STAs may perform NPCA using the channel access mode indicated by the NPCA AP. When the NPCA AP has a large amount of downlink data (data that needs to be transmitted to NPCA non-AP STAs) to process, it is considered more efficient for the NPCA AP to occupy the channel even if NPCA non-AP STAs might also have uplink data to process.

It might not always be possible for the NPCA AP and NPCA non-AP STAs to obtain traffic characteristic information of each other’s traffic. In an embodiment, if the NPCA AP is not able to obtain sufficient traffic characteristic information of the traffic of the NPCA non-AP STAs (e.g., when QoS/SCS/BSR information is unavailable and the NPCA-capable AP is only aware of its own (Tx) traffic), the NPCA AP may perform NPCA using the triggered channel access mode if the amount of buffered unit (BU) data in its queue is large and/or the BU data is low latency data (e.g., data that needs to be transmitted urgently), but the NPCA AP may perform NPCA using the untriggered channel access mode if the amount of BU data in its queue is not large and the BU data is not low latency data. After the NPCA AP determines the channel access mode it will use to perform NPCA, the NPCA AP may transmit an indication of this channel access mode to the NPCA non-AP STAs. When the NPCA AP operates in the triggered channel access mode, the NPCA non-AP STAs may switch channels to perform NPCA regardless of the amount of BU data in their queues so that they will be ready to receive data in case the NPCA AP has data to transmit to them. However, when the NPCA AP operates in the untriggered channel access mode, NPCA non-AP STAs may decide whether to switch channels to perform NPCA depending on whether they have BU data in their queues. NPCA non-AP STAs that have BU data in their queues may switch channels to perform NPCA but NPCA non-AP STAs that do not have BU data in their queues may remain on the primary channel (i.e., do not switch channels). When the NPCA AP has a large amount of BU data in its queue and/or the BU data is low latency data, it is preferable for the NPCA AP to occupy the channel with higher priority and transmit its BU data first. After the NPCA AP has transmitted some or all of its BU data, the NPCA AP may then solicit NPCA non-AP STAs to transmit their BU data.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

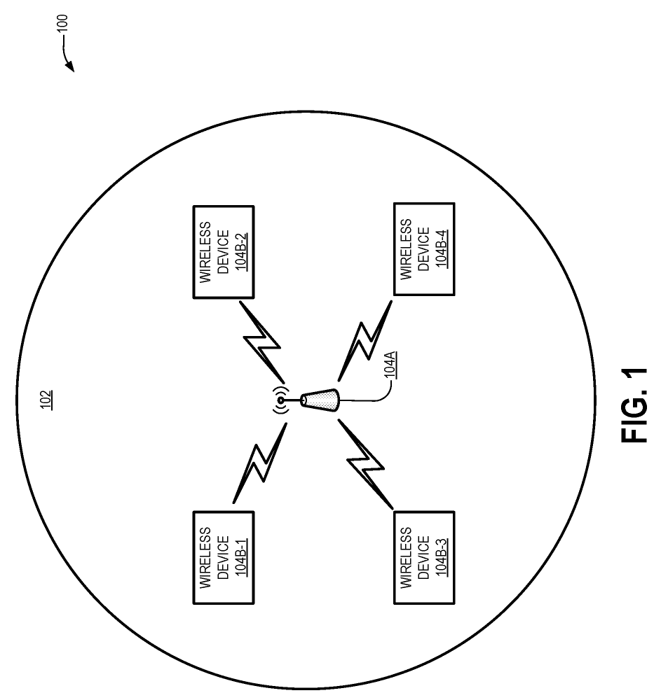

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

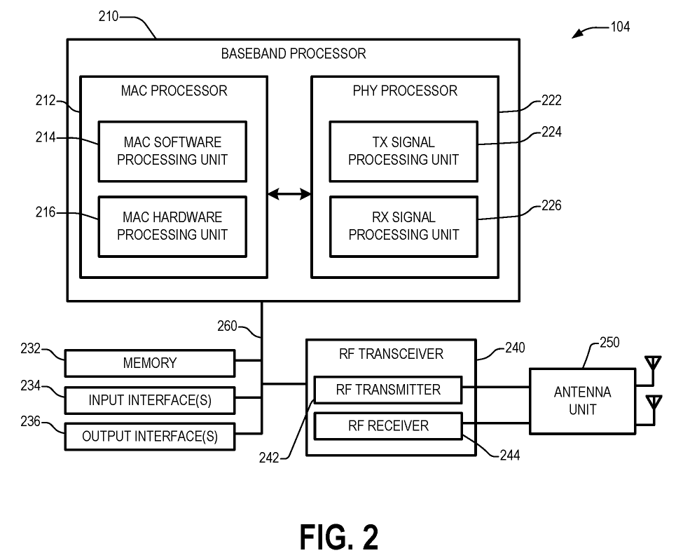

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

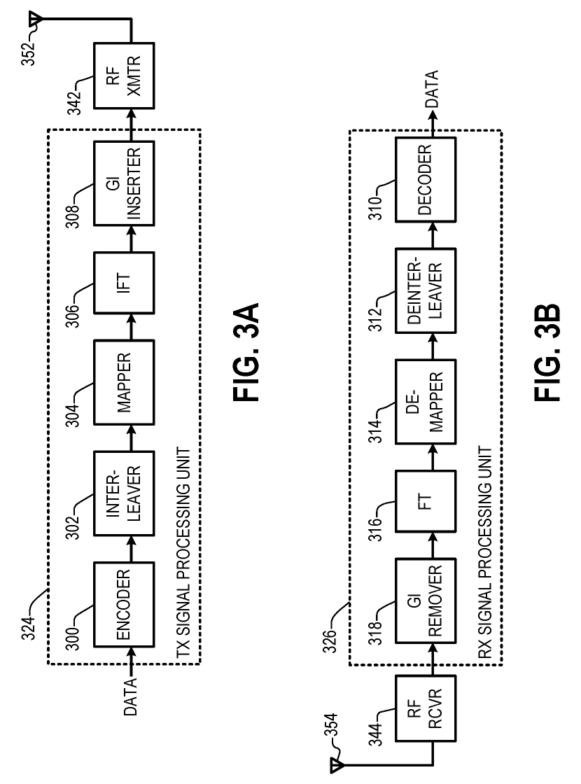

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20MHz, 40MHz, 80MHz, 160MHz, 240MHz, and 320MHz contiguous channel widths and support for an 80+80, 80+160MHz, and 160+160MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

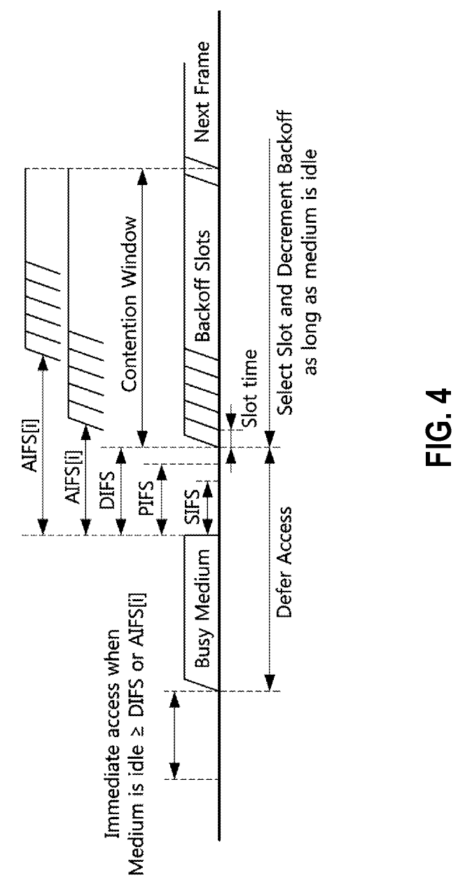

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

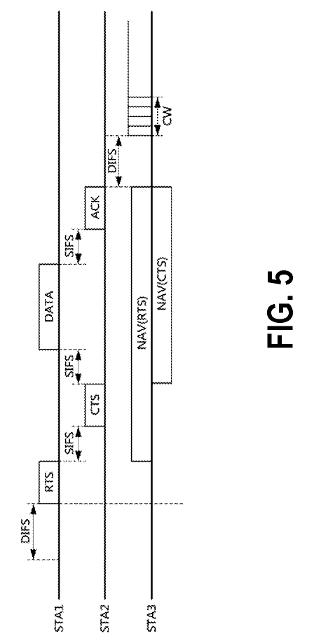

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

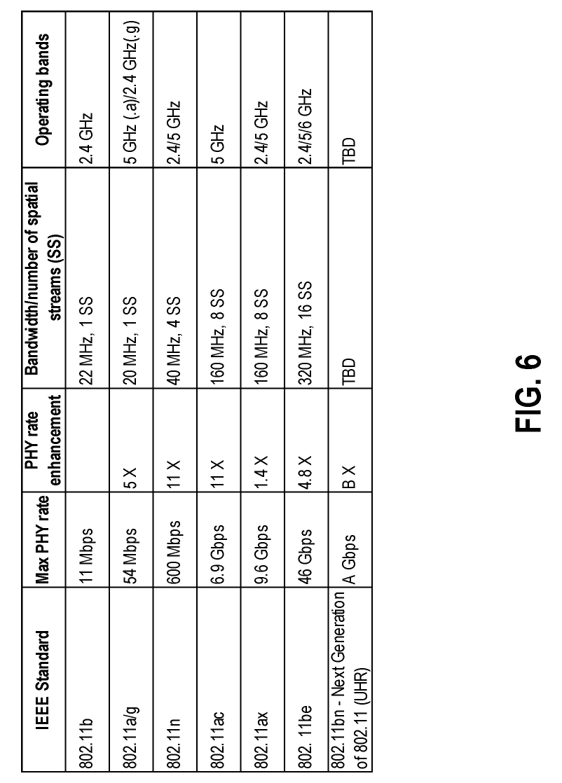

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6GHz) for IEEE 802.11be, more than 1GHz of additional unlicensed spectrum is likely to be available because the 6GHz band (5.925– 7.125GHz) is being considered for unlicensed use. This would allow APs and STAs to become tri-band devices. Larger than 160MHz data transmissions (e.g., 320MHz or 640MHz) could be considered to increase the maximum PHY rate. For example, 320MHz or 160+160MHz data could be transmitted in the 6GHz band. For example, 160+160MHz data could be transmitted across the 5 and 6GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

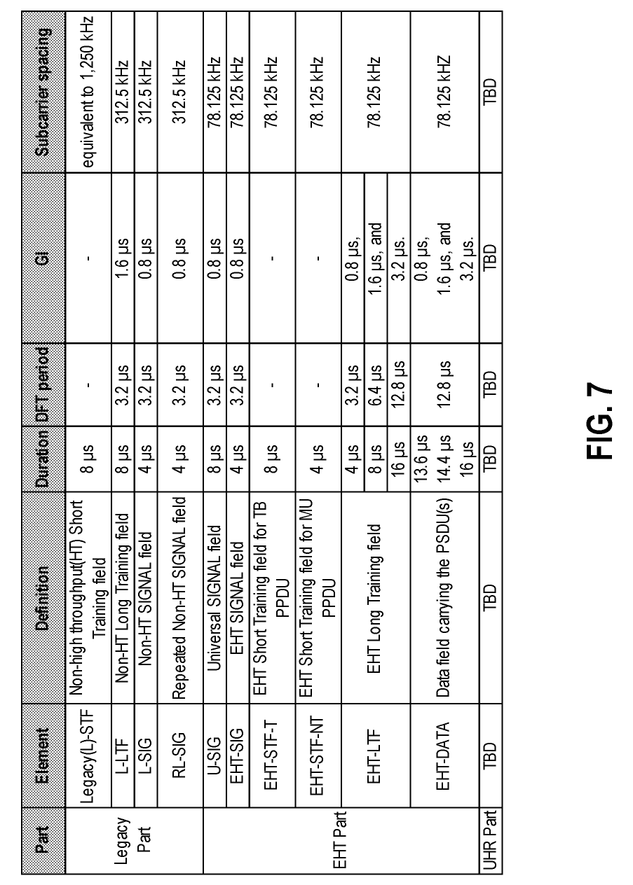

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

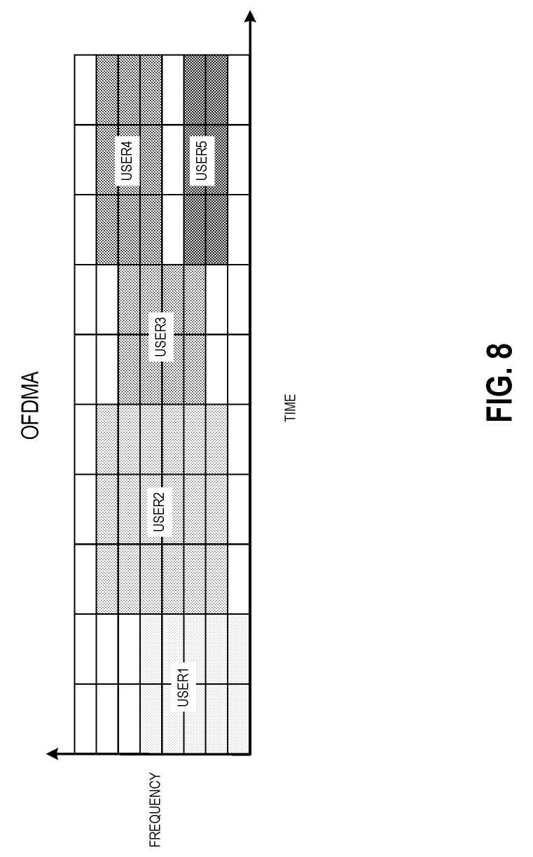

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

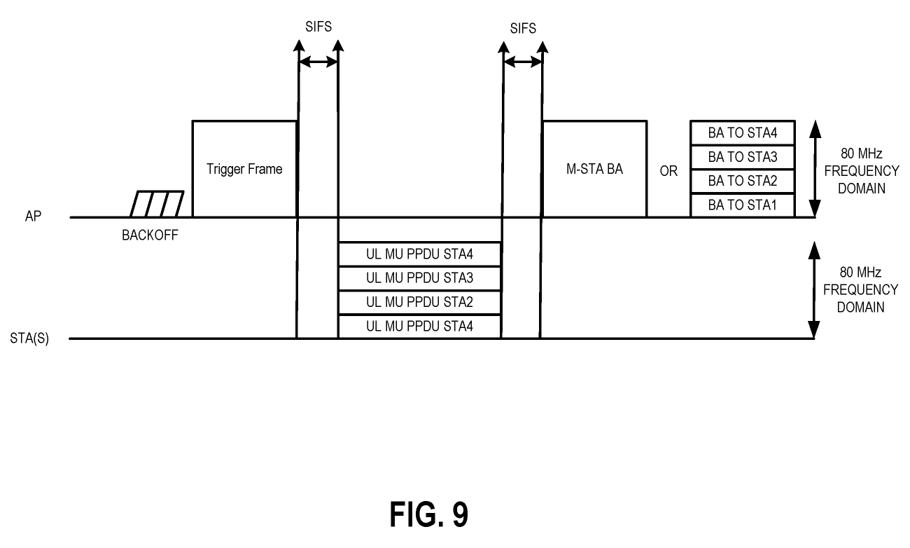

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (c-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

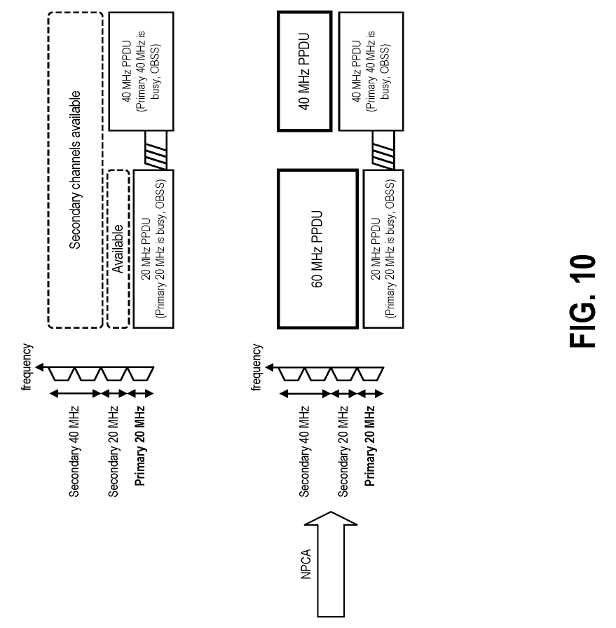

FIG. 10 is a diagram showing the overcall concept of NPCA, according to some embodiments.

The diagram shows the overall concept of NPCA when the operating bandwidth is 80MHz. It should be appreciated, however, that NPCA is not limited to being used with an 80MHz operating bandwidth but can be used with other operating bandwidth sizes. The 80MHz operating bandwidth may include a primary 20MHz (P20) channel, a secondary 20MHz (P20) channel, and a secondary 40MHz (S40) channel. As shown in the diagram, when a 20MHz PPDU is transmitted in the P20 channel, the S20 channel and the S40 channel may be available. Also, when a 40MHz PPDU is transmitted in the P40 channel, the S40 channel may be available. Traditional IEEE 802.11 wireless networks have a rule that does not allow transmission in non-primary channels (e.g., secondary channels) when the primary channel (e.g., the P20 channel) is busy even if the non-primary channels are idle.

In IEEE 802.11bn (also referred to as ultra high reliability (or “UHR”)), with the increase in the operating bandwidth (e.g., to 320MHz), the traditional rule that prevents PPDU transmission when the primary channel is busy and the secondary channel is idle (e.g., P20 channel is busy and secondary 160MHz (S160) channel is idle) is seen as inefficient and wasteful of resources. The concept of non-primary channel access (NPCA) has been proposed to address this issue. With NPCA, transmission and reception can be performed in an idle non-primary channel (e.g., a secondary channel) even if the primary channel is busy. That is, even if the primary channel is busy, if there is a non-primary channel that is idle, NPCA allows transmission/reception in the idle non-primary channel.

With NPCA, even if the primary channel is busy due to OBSS signals, transmission and reception may be allowed in a non-primary channel if certain conditions are met (e.g., clear channel assessment (CCA) indicates that the non-primary channel is idle). For example, as shown in the diagram, a 60MHz PPDU may be transmitted in the S20 channel and S40 channel while a 20MHz OBSS PPDU is transmitted in the P20 channel. As another example, a 40MHz PPDU may be transmitted in the S40 channel while a 40MHz OBSS PPDU is transmitted in the P20 channel and the S20 channel. By making use of otherwise unused non-primary channels, NPCA may improve channel utilization and thus improve the overall throughput in the wireless network.

Various terminology that will be used herein are now introduced.

As used herein, NPCA AP/STAs or NPCA-capable AP/STAs may refer to AP/STAs that are capable of performing NPCA.

As used herein, NPCA available channel may refer to a channel that can be used for NPCA operation.

As used herein, NPCA primary channel may refer to a subchannel (e.g., a 20MHz (sub)channel) of the NPCA available channel that is used for performing backoff for NPCA operation. The NPCA primary channel may perform a similar role to the primary channel that APs/STAs use during normal (non-NPCA) operation.

As used herein, MyBSS primary channel may refer to the primary channel of MyBSS/BSS.

As used herein, NPCA channel switching may refer to the act of switching from the MyBSS primary channel to the NPCA primary channel for NPCA operation.

As used herein, NPCA duration may refer to the duration during which NPCA can be performed.

NPCA AP/STAs may perform NPCA channel switching to perform NPCA when certain conditions are satisfied. The following general conditions should be satisfied in order to perform NPCA channel switching. The first general condition is that the primary channel of the BSS (MyBSS) is occupied by an overlapping basic service set (OBSS) physical layer protocol data unit (PPDU) that does not occupy the NPCA primary channel. The second condition is that the OBSS PPDU occupies the primary channel of the BSS for a duration that exceeds a NPCA minimum duration threshold. For example, if the OBSS PPDU is expected to occupy the primary channel of the BSS for a duration that is shorter than the NPCA minimum duration threshold, a NPCA AP/STA may decide not to perform NPCA channel switching but instead remain on the primary channel of the BSS. The purpose of having these conditions is to preemptively avoid issues such as device power drainage caused by excessive/unnecessary NPCA operations, as well as to ensure coexistence with legacy devices.

The present disclosure introduces additional conditions that should be satisfied to perform NPCA channel switching. Performing NPCA channel switching when these additional conditions are satisfied may enable more efficient NPCA operation by avoiding unnecessary/inefficient channel switching.

Before situations where NPCA channel switching can be performed arise, NPCA AP/STAs belonging to the same BSS may share traffic characteristic information of their traffic (traffic that they need to transmit/receive) in the BSS. The traffic characteristic information may include QoS information, SCS information, BSR information, or similar information. The traffic characteristic information that is shared may pertain to any traffic that the AP/STAs need to transmit/receive now or in the future (e.g., periodic traffic).

NPCA AP/STAs may share traffic characteristic information of their traffic with each other for various reasons. For example, NPCA AP/STAs may share traffic characteristic information of their traffic with each other for scheduling purposes to allow the NPCA AP to effectively handle the data of non-AP STAs (e.g., this may allow the AP to recognize when a non-AP STA has low latency traffic (e.g., AC_VO (voice access category) traffic) and prioritize this traffic for transmission during scheduling). As another example, NPCA AP/STAs may share traffic characteristic information of their traffic with each other to enable efficient NPCA operation.

The present disclosure describes channel switching conditions for NPCA that take pre-shared traffic characteristic information into consideration. A NPCA wireless device (e.g., a NPCA AP or NPCA non-AP STA) may determine, based on traffic characteristic information shared by other NPCA wireless devices, whether there is data to be processed between the NPCA wireless device and any of the other NPCA wireless devices. If the NPCA wireless device determines that there is data to be processed between itself and at least one NPCA wireless device, the NPCA wireless device may perform NPCA channel switching (switch from the primary channel of the BSS to the NPCA primary channel of the BSS) to perform NPCA (assuming other conditions for performing NPCA channel switching such as the general conditions mentioned above are also satisfied). However, if the NPCA wireless device determines there is no data to be processed between itself and the other NPCA wireless devices, the NPCA wireless device may remain on the primary channel of the BSS.

In an embodiment, the NPCA AP may determine whether to perform NPCA in an untriggered channel access mode or an untriggered channel access mode based on the traffic characteristic information shared in the BSS. For example, the NPCA AP may determine to perform NPCA using the triggered channel access mode if the traffic characteristic information shared in the BSS indicates that the amount of data to be processed between the NPCA AP and the NPCA non-AP STAs exceeds a predefined threshold amount, but determine to perform NPCA using the untriggered channel access mode if the amount of data to be processed between the NPCA AP and the NPCA non-AP STAs does not exceed the predefined threshold amount. In the triggered channel access mode, the NPCA AP is allowed to initiate channel access in the NPCA primary channel of the BSS but NPCA non-AP STAs are not allowed to initiate channel access in the NPCA primary channel of the BSS. In the untriggered channel access mode, both the NPCA AP and the NPCA non-AP STAs are allowed to initiate channel access in the NPCA primary channel of the BSS.

In some situations, it might not be possible to obtain complete traffic characteristic information of the traffic of other NPCA wireless devices. This could be the case, for example, if problems occur with interpreting traffic characteristic information shared by other NPCA wireless devices or if other NPCA wireless devices do not share traffic characteristic information or share insufficient traffic characteristic information. In such case, a NPCA AP may determine which channel access mode to use to perform NPCA based on the amount of buffered low latency data in its own queue. For example, the NPCA AP may determine to use the triggered channel access mode if the amount of buffered low latency data in its queue exceeds a predefined threshold amount but may determine to use the untriggered channel access mode if the amount of buffered low latency data in its queue does not exceed the predefined threshold amount. The NPCA AP may transmit an indication of the channel access mode it will use to the NPCA non-AP STAs. When the NPCA AP indicates that it will use the triggered channel access mode, the NPCA non-AP STA may perform NPCA channel switching regardless of the amount of buffered data in their queues. However, when the NPCA AP indicates that it will use the untriggered channel access mode, the NPCA non-AP STAs may only perform NPCA channel switching if they have buffered data in their queues. That is, a NPCA non-AP STA that has buffered data in its queue may perform NPCA channel switching to perform NPCA, while a NPCA non-AP STA that does not have buffered data in its queue may remain on the primary channel of the BSS.

The situation where NPCA wireless devices have traffic characteristic information of the traffic of other NPCA wireless devices may be referred to herein as Situation 1. The situation where NPCA wireless devices do not have sufficient traffic characteristic information of the traffic of other NPCA wireless devices may be referred to herein as Situation 2.

In Situation 1, NPCA wireless devices may determine whether to perform NPCA channel switching by considering both the general conditions mentioned above and additional conditions. The additional conditions may relate to whether there is data to process between the NPCA wireless devices, which can be determined based on traffic characteristic information shared among the NPCA wireless devices.

For example, a NPCA AP may determine whether there is data to be processed between itself and any NPCA non-AP STAs (e.g., is there data for the NPCA AP to transmit to any of the NPCA non-AP STAs and/or data for the NPCA non-AP STAs to transmit to the NPCA AP) based on the traffic characteristic information shared among the NPCA AP/STAs. If there is data to process, the NPCA AP may perform NPCA channel switching. Otherwise, if there is no data to process, the NPCA AP may remain on the primary channel of its BSS (i.e., does not perform NPCA channel switching). Similarly, a NPCA (non-AP) STA may determine whether is data to be processed between itself and the NPCA AP based on the traffic characteristic information shared among the NPCA AP/STAs. If there is data to process, the NPCA non-AP STA may perform NPCA channel switching to perform NPCA. Otherwise, if there is no data to process, the NPCA non-AP STA may remain on the primary channel of its BSS (i.e., does not perform NPCA channel switching). This condition ensures that NPCA AP/STAs only perform NPCA channel switching when there is data to be processed. This reduces unnecessary NPCA channel switching and prevents power drain issues that can arise due to frequent/unnecessary NPCA channel switching.

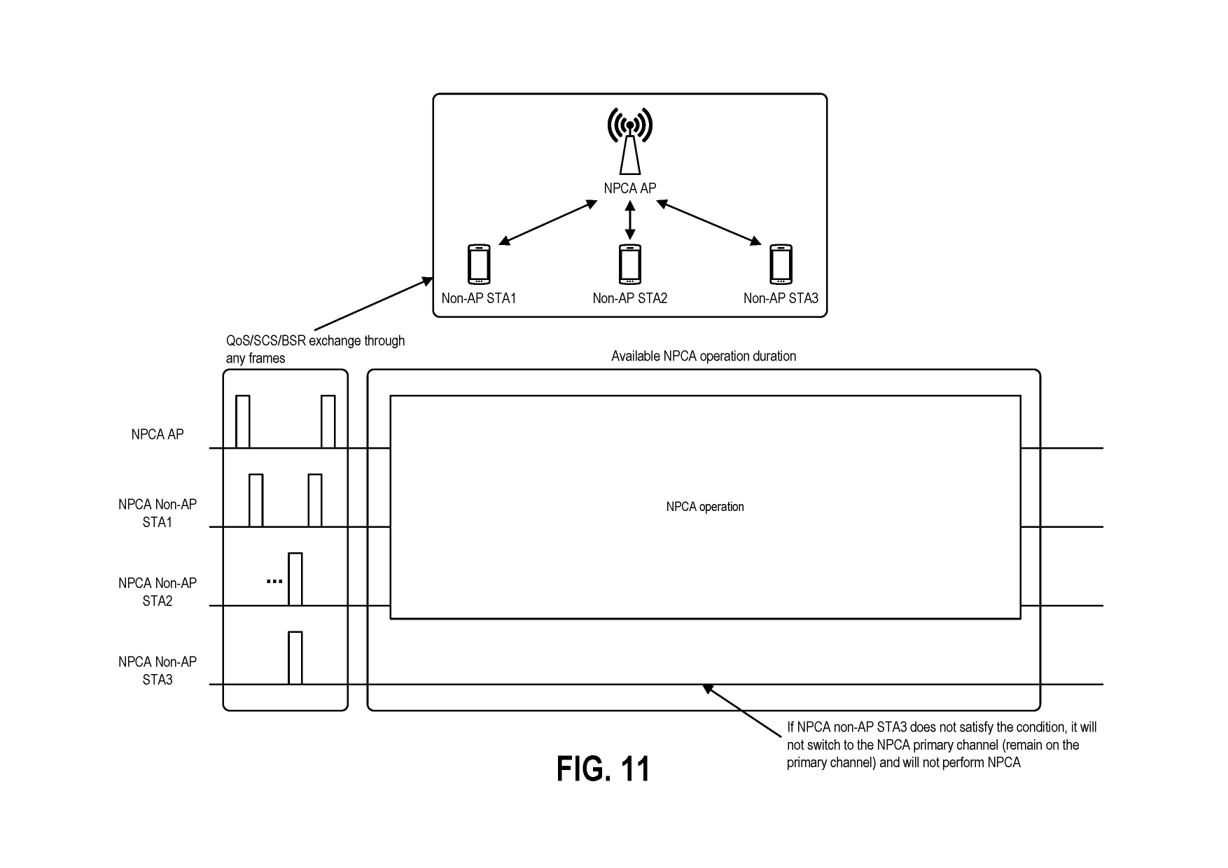

FIG. 11 is a diagram showing an example of performing NPCA after the sharing of traffic characteristic information among NPCA wireless devices, according to some embodiments.

As shown in the diagram, a BSS may include a NPCA AP, a first NPCA non-AP STA (NPCA non-AP STA1), a second NPCA non-AP STA (NPCA non-AP STA2), and a third NPCA non-AP STA (NPCA non-AP STA3). The NPCA AP and the NPCA non-AP STAs may share traffic characteristic information of their traffic (traffic that they have to transmit and/or receive) with each other through the exchange of frames. The traffic characteristic information may includes QoS information, SCS information, and/or BSR information.

The NPCA AP and the NPCA non-AP STAs may each determine, based on the traffic characteristic information that was shared in the BSS, whether there is data to be processed between itself and another member of its BSS. If a NPCA AP/STA determines that there is data to be processed between itself and another member of the BSS, the NPCA AP/STA may perform NPCA channel switching. Otherwise, if a NPCA AP/STA determines that there is no data to be processed between itself and another member of the BSS, the NPCA AP/STA may remain on the primary channel of the BSS. In this example it is assumed that NPCA AP, NPCA non-AP STA1, and NPCA non-AP STA2 have data to be processed (e.g., data to transmit/receive) and thus perform NPCA channel switching to perform NPCA during the available NPCA operation duration. However, in this example, it is assumed that NPCA non-AP STA3 does not have data to be processed and thus remains on the primary channel of the BSS and thus does not perform NPCA during the available NPCA operation duration.

In an embodiment, the NPCA AP determine whether to perform NPCA using a triggered channel access mode or an untriggered channel access mode depending on the traffic characteristic information shared in the BSS. In the triggered channel access mode, the NPCA AP may perform enhanced distributed channel access (EDCA) in the NPCA primary channel, and initiate transmission/reception with NPCA non-AP STAs in the NPCA primary channel if it succeeds in occupying the channel. Only the NPCA AP is allowed to initiate channel access in the triggered channel access mode. NPCA non-AP STAs are not allowed to initiate channel access in the triggered channel access mode. In the untriggered channel access mode, both the NPCA AP and the NPCA non-AP STAs may perform EDCA in the NPCA primary channel, and initiate transmission/reception in the NPCA primary channel if it succeeds in occupying the channel. Both the NPCA AP and the NPCA non-AP STAs are allowed to initiate channel access in the untriggered channel access mode.

As mentioned above, the NPCA AP may determine which channel access mode to use based on traffic characteristic information shared in the BSS. For example, if the NPCA AP determines, based on the traffic characteristic information, that there is a sufficient amount of data to process between the NPCA AP and the NPCA non-AP STAs (e.g., sufficient amount of downlink data), the NPCA AP may decide to perform NPCA using the triggered channel access mode because it is considered more efficient for the NPCA AP to occupy the channel in this case. The NPCA AP may then transmit an indication to the NPCA non-AP STAs that they should use the triggered channel access mode when performing NPCA. The indication (to use the triggered channel access mode) may be transmitted in a management frame or an action frame.

If, however, the NPCA AP determines, based on the traffic characteristic information, that there is not a sufficient amount of data to process between the NPCA AP and the NPCA non-AP STAs, the NPCA AP may decide to perform NPCA using the untriggered channel access mode because it is considered more efficient to allow NPCA non-AP STAs to occupy the channel in this case. The NPCA AP may then transmit an indication to the NPCA non-AP STAs that they should use the untriggered channel access mode when performing NPCA. The indication (to use the untriggered channel access mode) may be transmitted in a management frame or an action frame.

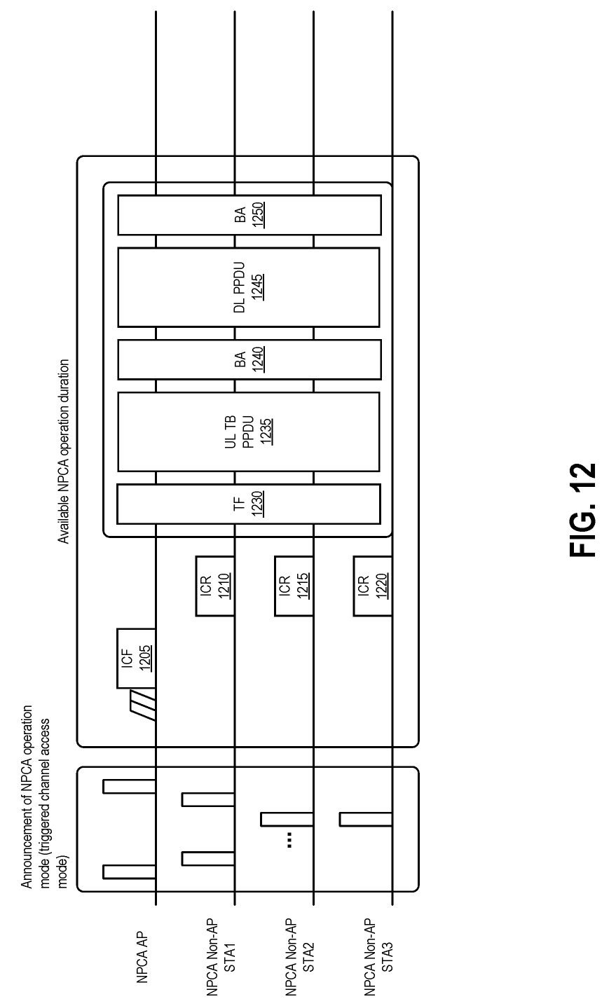

FIG. 12 is a diagram showing an example of performing NPCA using the triggered channel access mode, according to some embodiments.

The NPCA AP and the NPCA non-AP STAs may share traffic characteristic information of their traffic (traffic that they have to transmit and/or receive) with each other through the exchange of frames. The traffic characteristic information may includes QoS information, SCS information, and/or BSR information.

The NPCA AP may determine, based on the traffic characteristic information shared in the BSS, that there is a sufficient amount data to process between the NPCA AP and the NPCA non-AP STAs (NPCA non-AP STA1, NPCA non-AP STA2, and NPCA non-AP STA3), and thus decide to perform NPCA using the triggered channel access mode. Accordingly, the NPCA AP may transmit an indication to the NPCA non-AP STAs to perform NPCA using the triggered channel access mode.

It is assumed in this example that the traffic characteristic information shared in the BSS indicates that there is data to be processed between the NPCA AP and the NPCA non-AP STAs (NPCA non-AP STA1, NPCA non-AP STA2, and NPCA non-AP STA3). Thus, the NPCA AP and the NPCA non-AP STAs perform NPCA channel switching to perform NPCA during the available NPCA operation duration.

During the available NPCA operation duration, the NPCA AP may transmit an initial control frame (ICF) 1205 and the NPCA non-AP STAs may respond by transmitting initial control response frames (specifically, NPCA non-AP STA1 may transmit ICR 1210, NPCA non-AP STA2 may transmit ICR 1215, and NPCA non-AP STA3 may transmit ICR 1220). The NPCA AP may then transmit a trigger frame (TF) 1230 to solicit an uplink transmission from the NPCA non-AP STAs. Responsive to receiving trigger frame 1230, the NPCA non-AP STAs may transmit an uplink trigger-based PPDU (UL TB PPDU) 1235 to the NPCA AP (e.g., as a UL MU simultaneous transmission). The NPCA AP may then transmit a block acknowledgement (BA) frame 1240 to the NPCA non-AP STAs to acknowledge successful reception of the UL TB PPDU 1235. The NPCA AP may then transmit a downlink PPDU (DL PPDU) 1245 to the NPCA non-AP STAs and the NPCA non-AP STAs may transmit block acknowledgment frame 1250 to the NPCA AP to acknowledge successful reception of the DL PPDU 1245.

In Situation 2 (e.g., a situation where complete traffic characteristic information is not shared/available in the BSS), NPCA wireless devices may determine whether to perform NPCA channel switching by considering both the general conditions mentioned above and additional conditions. The additional conditions may relate to whether there is a sufficient amount of buffered low latency data queued at the NPCA wireless device.

Situation 2 may occur because traffic characteristic information is not shared among the NPCA AP/STAs in the BSS or because the traffic characteristic information that is shared among the NPCA AP/STAs is insufficient to determine whether there is data to be processed between NPCA AP/STAs.

In Situation 2, the NPCA AP and the NPCA non-AP STAs are only aware of the buffered data in their own queues. The NPCA AP may determine which channel access mode to use when performing NPCA based on the amount of buffered low latency data in its queue. For example, if the NPCA AP has a significant amount of buffered data in its queue and this data is low latency data (data that has to be transmitted urgently), the NPCA AP may decide to perform NPCA using the triggered channel access mode. The NPCA AP may transmit an indication to the NPCA non-AP STAs in its own BSS to use the triggered channel access mode when performing NPCA. The indication may be transmitted in a management frame or an action frame. Upon receiving such an indication (to use the triggered channel access mode), the NPCA non-AP STAs may perform NPCA channel switching without considering the amount of buffered data they have in their own queues. This behavior is justified because the NPCA AP’s indication to use the triggered channel access mode indicates that the NPCA AP has a significant amount of buffered low latency data to transmit to the NPCA non-AP STAs so the NPCA non-AP STAs should be ready to receive the data from the NPCA AP.

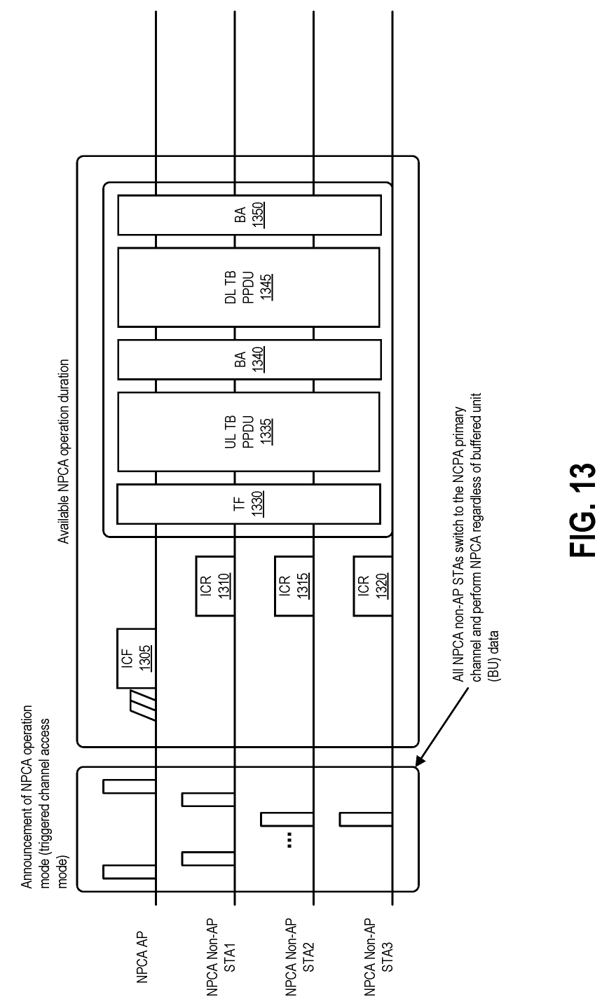

FIG. 13 is a diagram showing an example of performing NPCA using the triggered channel access mode and where all NPCA non-AP STAs perform NPCA channel switching without considering queued buffered data, according to some embodiments.

It is assumed in this example that the NPCA AP and the NPCA non-AP STAs (e.g., NPCA non-AP STA1, NPCA non-AP STA2, and NPCA non-AP STA3) do not have traffic characteristic information of the traffic of other devices (the NPCA AP and the NPCA non-AP STAs only have information regarding their own traffic).

The NPCA AP may determine that it has a sufficient amount of buffered low latency data in its queue, and thus decide to perform NPCA using the triggered channel access mode. The NPCA AP may transmit an indication to the non-AP STAs to use the triggered channel access mode when performing NPCA (e.g., using management frames or action frames) (this is shown as “Announcement of NPCA operation” in the diagram). Responsive to receiving such indication (to use the triggered channel access mode), all of the NPCA non-AP STAs may perform NPCA channel switching (switch from the primary channel of the BSS to the NPCA primary channel of the BSS) to perform NPCA (when the general conditions are satisfied) regardless of the state of its queue and use the triggered channel access mode during the available NPCA operation duration.

During the available NPCA operation duration, the NPCA AP may transmit an initial control frame (ICF) 1305 and the NPCA non-AP STAs may respond by transmitting initial control response frames (specifically, NPCA non-AP STA1 may transmit ICR 1310, NPCA non-AP STA2 may transmit ICR 1315, and NPCA non-AP STA3 may transmit ICR 1320). The NPCA AP may transmit a trigger frame (TF) 1330 to solicit an uplink transmission from the NPCA non-AP STAs. Responsive to receiving TF 1330, the NPCA non-AP STAs may transmit an uplink trigger-based PPDU (UL TB PPDU) 1335 to the NPCA AP. The NPCA AP may then transmit a block acknowledgement (BA) frame 1340 to the NPCA non-AP STAs to acknowledge successful reception of the UL TB PPDU 1335. The NPCA AP may then transmit a downlink PPDU (DL PPDU) 1345 to the NPCA non-AP STAs and the NPCA non-AP STAs may transmit block acknowledgement frame 1350 to the NPCA AP to acknowledge successful reception of the DL PPDU 1345.

If the NPCA AP does not have a sufficient amount of buffered data in its queue or if the buffered data does not require urgent processing (the data is non-low latency data), the NPCA AP may decide to perform NPCA using the untriggered channel access mode. The NPCA AP may transmit an indication to the NPCA non-AP STAs to use the untriggered channel access mode when performing NPCA. The indication may be transmitted in a management frame or an action frame. Upon receiving such an indication (to use the untriggered channel access mode), each of the NPCA non-AP STAs may consider its own buffered data when deciding whether to perform NPCA channel switching or not. For example, a NPCA non-AP STA that does not have buffered data in its queue may decide not to perform NPCA channel switching (remain on the primary channel). However, a NPCA non-AP STA that does have buffered data in its queue may decide to perform NPCA channel switching. The rationale for this behavior is that the untriggered channel access mode allows NPCA non-AP STAs to participate in EDCA in the NPCA primary channel and only NPCA non-AP STAs having buffered data in their queues need to participate in EDCA. NPCA non-AP STAs that do not have buffed data in their queues do not need to perform NPCA channel switching since they do not have data to transmit.

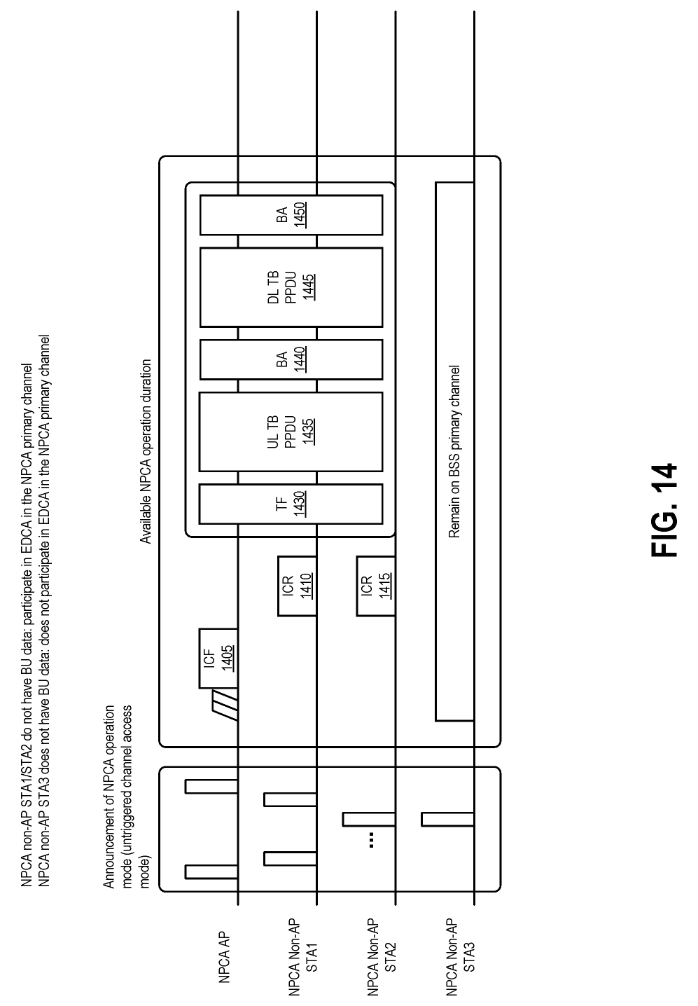

FIG. 14 is a diagram showing an example of performing NPCA using the untriggered channel access mode and where NPCA non-AP STAs decide whether to perform NPCA channel switching considering the buffered data in their own queues, according to some embodiments.

It is assumed in this example that the NPCA AP and the NPCA non-AP STAs (e.g., NPCA non-AP STA1, NPCA non-AP STA2, and NPCA non-AP STA3) do not have traffic characteristic information of the traffic of other devices (the NPCA AP and the NPCA non-AP STAs only have information regarding their own traffic).

The NPCA AP may determine that it does not have a sufficient amount of buffered low latency data in its queue, and thus decide to perform NPCA using the untriggered channel access mode. The NPCA AP may transmit an indication to the non-AP STAs to use the untriggered channel access mode when performing NPCA (e.g., using management frames or action frames). Responsive to receiving such indication (to use the untriggered channel access mode), the NPCA non-AP STAs that have buffered data in their queues may perform NPCA channel switching (switch from the primary channel of the BSS to the NPCA primary channel of the BSS when the general conditions are satisfied) to perform NPCA, but the NPCA non-AP STAs that do not have buffered data in their queues may remain on the primary channel of the BSS. In the example shown in the diagram, it is assumed that NPCA non-AP STA1 and NPCA non-AP STA2 have buffered data in their queues but that NPCA non-AP STA3 does not have buffered data in its queue. Thus, NPCA non-AP STA1 and NPCA non-AP STA2 may perform NPCA channel switching to perform NPCA (when the general conditions are satisfied) but NPCA non-AP STA3 may remain on the primary channel of the BSS (i.e., does not perform NPCA channel switching).

During the available NPCA operation duration, the NPCA AP, NPCA non-AP STA1 and NPCA non-AP STA2 may participate in EDCA to occupy the channel (since they are operating in the untriggered channel access mode). In this example, it is assumed that the NPCA AP successfully occupies the channel as a result of performing EDCA. After occupying the channel, the NPCA AP may transmit an initial control frame (ICF) 1405 and the NPCA non-AP STAs that performed NPCA channel switching may respond by transmitting initial control response frames (specifically, NPCA non-AP STA1 may transmit ICR 1410 and NPCA non-AP STA2 may transmit ICR 1415). The NPCA AP may transmit a trigger frame (TF) 1430 to solicit an uplink transmission from NPCA non-AP STA1 and NPCA non-AP STA2. Responsive to receiving trigger frame 1430, NPCA non-AP STA1 and NPCA non-AP STA2 may transmit an uplink trigger-based PPDU (UL TB PPDU) 1435 to the NPCA AP. The NPCA AP may then transmit a block acknowledgement (BA) frame 1440 to NPCA non-AP STA1 and NPCA non-AP STA2 to acknowledge successful reception of the UL TB PPDU 1435. The NPCA AP may then transmit a downlink PPDU (DL PPDU) 1445 to NPCA non-AP STA1 and NPCA non-AP STA2 and these NPCA non-AP STAs may transmit block acknowledgement (BA) frame 1450 to the NPCA AP to acknowledge successful reception of the DL PPDU 1445.

Additional conditions for performing NPCA channel switching have been described herein. Applying these additional conditions when deciding whether to perform NPCA channel switching may help avoid unnecessary channel switching and thus avoid unnecessary power drainage of devices.

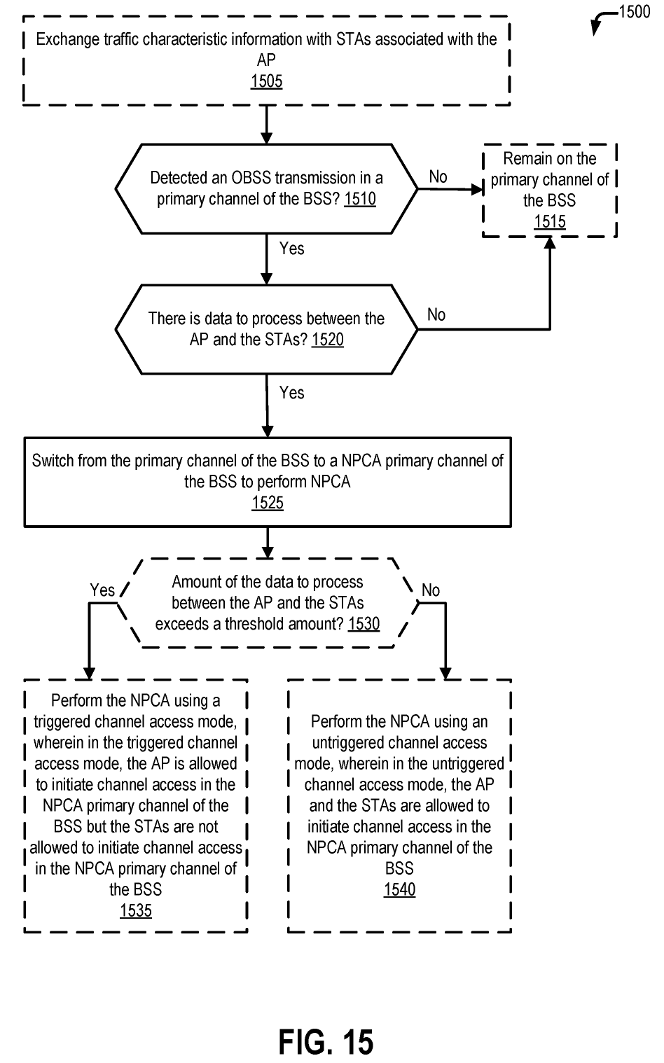

Turning now to FIG. 15, a method 1500 will be described for deciding whether to perform NPCA channel switching, in accordance with an example embodiment. The method 1500 may be performed by an AP operating a BSS. The AP may be implemented by a wireless device (e.g., wireless device 104).

Additionally, although shown in a particular order, in some embodiments the operations of the method 1500 (and the other methods shown in the other figures) may be performed in a different order. For example, although the operations of the method 1500 are shown in a sequential order, some of the operations may be performed in partially or entirely overlapping time periods.

In an embodiment, at operation 1505, the AP exchanges traffic characteristic information with STAs associated with the AP.

At operation 1510, the AP determines whether it has detected an OBSS transmission in a primary channel of the BSS (e.g., detected an OBSS PPDU occupying the primary channel of the BSS). If the AP has not detected an OBSS transmission in the primary channel of the BSS, the flow may move to operation 1515, at which the AP remains on the primary channel of the BSS (i.e., does not perform NPCA channel switching). Otherwise, if the AP has detected an OBSS transmission in the primary channel of the BSS, the flow may move to operation 1520.

At operation 1520, the AP may determine whether there is data to process between the AP and the STAs associated with the AP. In an embodiment, the determination of whether there is data to process between the AP and the STAs is based on traffic characteristic information exchanged with the STAs. The traffic characteristic information may include one or more of: QoS information, SCS information, and BSR information. If the AP determines there is no data to process between the AP and the STAs, the flow may move to operation 1515, at which the AP remains on the primary channel of the BSS. However, if the AP determines that there is data to process between the AP and the STAs, the flow may move to operation 1525.

At operation 1525, the AP switches from the primary channel of the BSS to a NPCA primary channel of the BSS to perform NPCA (i.e., performs NPCA channel switching).

In an embodiment, at operation 1530, the AP determines whether the amount of data to process between the AP and STAs exceeds a threshold amount (operation 1530 may be performed before operation 1510 in some embodiments). If the AP determines that the amount of data to process between the AP and the STAs exceeds the threshold amount, the flow may proceed to operation 1535. In an embodiment, at operation 1535, the AP performs the NPCA using a triggered channel access mode, wherein in the triggered channel access mode, the AP is allowed to initiate channel access in the NPCA primary channel of the BSS but the STAs are not allowed to initiate channel access in the NPCA primary channel of the BSS. In an embodiment, the AP transmits a frame to the STAs that indicates that the STAs are to perform the NPCA using the triggered channel access mode. In an embodiment, performing the NPCA using the triggered channel access mode comprises transmitting a trigger frame to at least one of the STAs in the NPCA primary channel of the BSS to solicit an uplink transmission.

Otherwise, if the AP determines that the amount of data to process between the AP and the STAs does not exceed the threshold amount, the flow may proceed to operation 1540. In an embodiment, at operation 1540, the AP performs the NPCA using an untriggered channel access mode, wherein in the untriggered channel access mode, the AP and the STAs are allowed to initiate channel access in the NPCA primary channel of the BSS. In an embodiment, the AP transmits a frame to the STAs that indicates that the STAs are to perform the NPCA using the untriggered channel access mode.

In an embodiment, the AP performs the NPCA by exchanging frames with at least one of the STAs in the NPCA primary channel of the BSS.

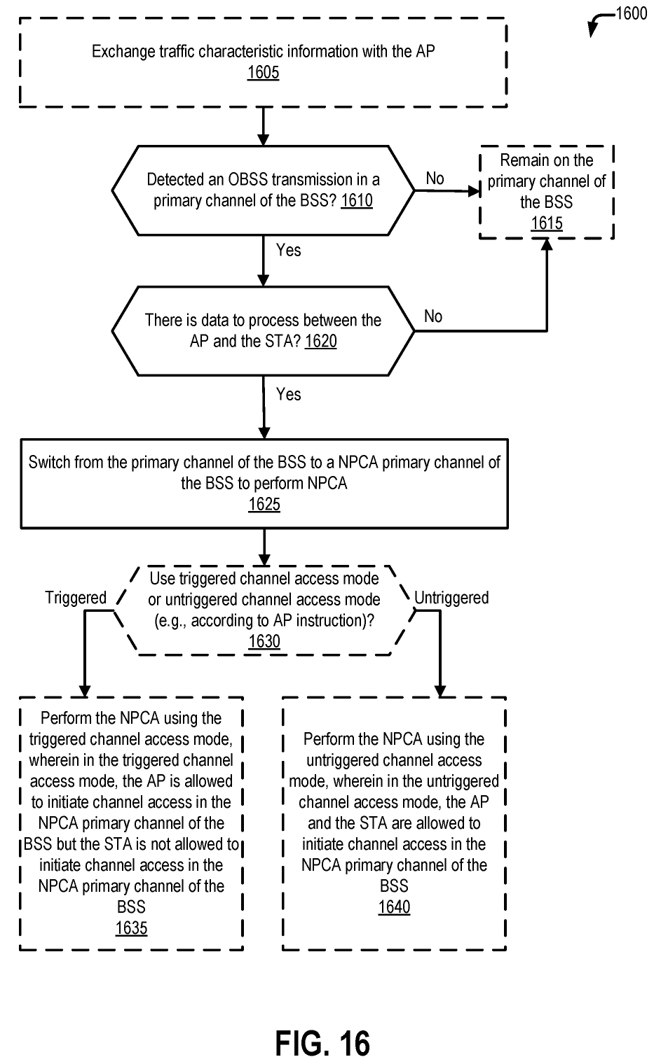

Turning now to FIG. 16, a method 1600 will be described for deciding whether to perform NPCA channel switching, in accordance with an example embodiment. The method 1600 may be performed by a non-AP STA that belongs to a BSS operated by an AP. The non-AP STA may be implemented by a wireless device (e.g., wireless device 104).

In an embodiment, at operation 1605, the STA exchanges traffic characteristic information with the AP.

At operation 1610, the STA determines whether it has detected an OBSS transmission in a primary channel of the BSS (e.g., detected an OBSS PPDU occupying the primary channel of the BSS). If the AP has not detected an OBSS transmission in the primary channel of the BSS, the flow may move to operation 1615, at which the STA remains on the primary channel of the BSS (i.e., does not perform NPCA channel switching). Otherwise, if the STA has detected an OBSS transmission in the primary channel of the BSS, the flow may move to operation 1620.

At operation 1620, the STA may determine whether there is data to process between the AP and the STA. In an embodiment, the determination of whether there is data to process between the AP and the STA is based on traffic characteristic information exchanged with the AP. The traffic characteristic information may include one or more of: QoS information, SCS information, and BSR information. If the STA determines there is no data to process between the AP and the STA, the flow may move to operation 1615, at which the STA remains on the primary channel of the BSS. However, if the STA determines that there is data to process between the AP and the STA, the flow may move to operation 1625.

At operation 1625, the STA switches from the primary channel of the BSS to a NPCA primary channel of the BSS to perform NPCA (i.e., performs NPCA channel switching). In an embodiment, the STA performs the NPCA by exchanging frames with the AP in the NPCA primary channel of the BSS.

In an embodiment, at operation 1630, the STA determines whether to use a triggered channel access mode or an untriggered channel access mode. The STA may determine which mode to use based on an indication/instruction received from the AP. If the STA determines to use the triggered channel access mode, the flow may move to operation 1635. In an embodiment, at operation 1635, the STA performs the NPCA using the triggered channel access mode, wherein in the triggered channel access mode, the AP is allowed to initiate channel access in the NPCA primary channel of the BSS but the STA is not allowed to initiate channel access in the NPCA primary channel of the BSS.

Otherwise, if the STA determines to use the untriggered channel access mode, the flow may move to operation 1640. In an embodiment, at operation 1640, the STA performs the NPCA using the untriggered channel access mode, wherein in the untriggered channel access mode, the AP and the STA are allowed to initiate channel access in the NPCA primary channel of the BSS.

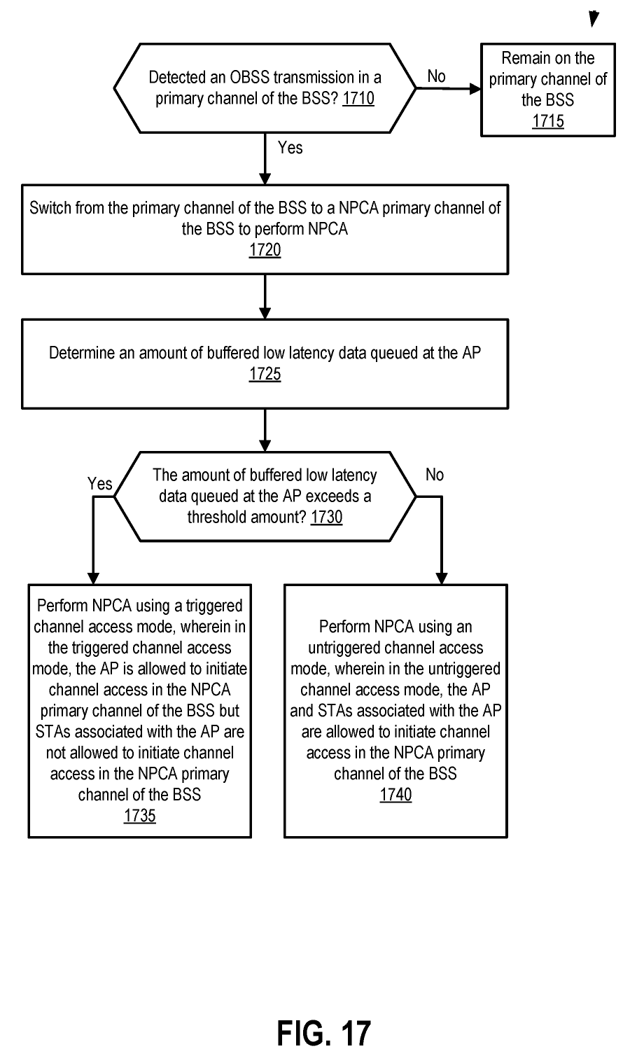

Turning now to FIG. 17, a method 1700 will be described for deciding which channel access mode to use when performing NPCA, in accordance with an example embodiment. The method 1700 may be performed by an AP operating a BSS. The AP may be implemented by a wireless device (e.g., wireless device 104).

At operation 1710, the AP determines whether it has detected an OBSS transmission in a primary channel of the BSS (e.g., detected an OBSS PPDU occupying the primary channel of the BSS). If the AP has not detected an OBSS transmission in the primary channel of the BSS, the flow may move to operation 1715, at which the AP remains on the primary channel of the BSS (i.e., does not perform NPCA channel switching). Otherwise, if the AP has detected an OBSS transmission in the primary channel of the BSS, the flow may move to operation 1720.

At operation 1720, the AP switches from the primary channel of the BSS to a NPCA primary channel of the BSS to perform NPCA (i.e., performs NPCA channel switching).

At operation 1725, the AP determines an amount of buffered low latency data queued at the AP (operation 1725 may be performed before operation 1710 in some embodiments).

At operation 1730, the AP determines whether the amount of buffered low latency data queued at the AP exceeds a threshold amount. If the AP determines that the amount of buffered low latency data queued at the AP exceeds the threshold amount, the flow may move to operation 1735. At operation 1735, the AP performs NPCA using a triggered channel access mode, wherein in the triggered channel access mode, the AP is allowed to initiate channel access in the NPCA primary channel of the BSS but STAs associated with the AP are not allowed to initiate channel access in the NPCA primary channel of the BSS. In an embodiment, performing the NPCA using the triggered channel access mode comprises transmitting a trigger frame to at least one of the STAs in the NPCA primary channel of the BSS to solicit an uplink transmission. In an embodiment, the AP transmits a frame to the STAs that indicates that the STAs are to perform the NPCA using the triggered channel access mode.

Otherwise, if the AP determines that the amount of buffered low latency data queued at the AP does not exceed the threshold amount, the flow may move to operation 1740. At operation 1740, the AP performs NPCA using an untriggered channel access mode, wherein in the untriggered channel access mode, the AP and STAs associated with the AP are allowed to initiate channel access in the NPCA primary channel of the BSS. In an embodiment, the AP transmits a frame to the STAs that indicates that the STAs are to perform the NPCA using the untriggered channel access mode.

In an embodiment, the AP may decide to use the triggered channel access mode if the amount of buffered data queued at the AP exceeds a threshold amount or if there is low latency data queued at the AP but otherwise decide to use the untriggered channel access mode.

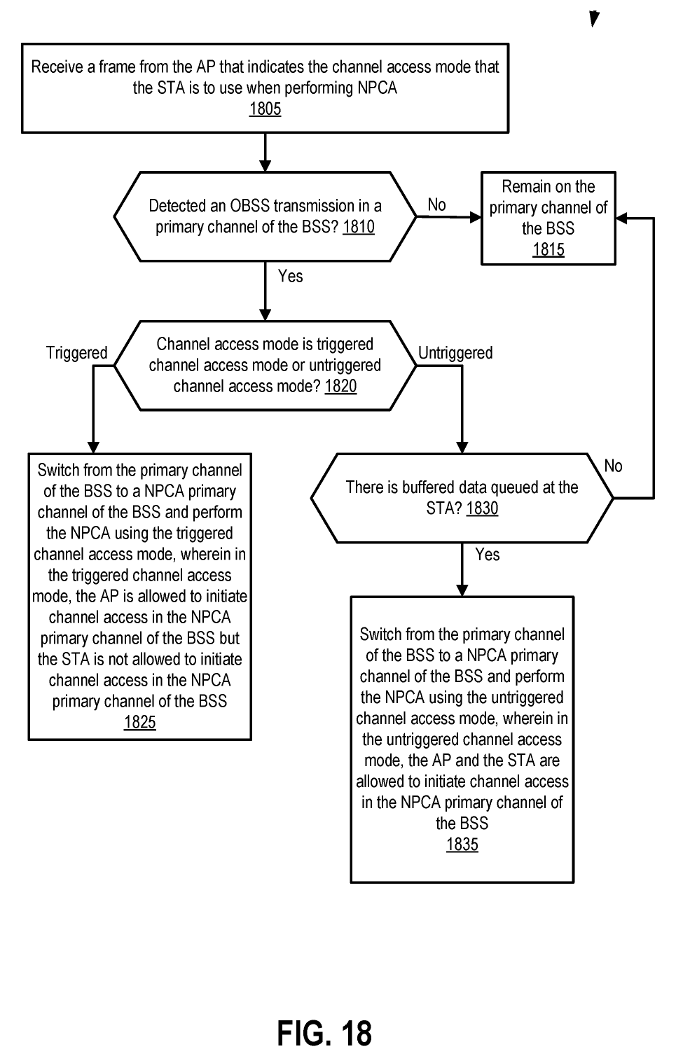

Turning now to FIG. 18, a method 1800 will be described for deciding whether to perform NPCA channel switching, in accordance with an example embodiment. The method 1800 may be performed by a non-AP STA that belongs to a BSS operated by an AP. The non-AP STA may be implemented by a wireless device (e.g., wireless device 104).

At operation 1805, the STA receives a frame from the AP that indicates the channel access mode that the STA is to use when performing NPCA (triggered channel access mode or untriggered channel access mode).

At operation 1810, the STA determines whether it has detected an OBSS transmission in a primary channel of the BSS (e.g., detected an OBSS PPDU occupying the primary channel of the BSS). If the STA has not detected an OBSS transmission in the primary channel of the BSS, the flow may move to operation 1815, at which the STA remains on the primary channel of the BSS (i.e., does not perform NPCA channel switching). Otherwise, if the STA has detected an OBSS transmission in the primary channel of the BSS, the flow may move to operation 1820.

At operation 1820, the STA may determine whether to use a triggered channel access mode or an untriggered channel access mode. The STA may determine which channel access mode to use based on the indication/instruction received from the AP (e.g., the indication received at operation 1805). If the STA determines to use the triggered channel access mode, the flow may move to operation 1825. At operation 1825, the STA switches from the primary channel of the BSS to a NPCA primary channel of the BSS (i.e., performs NPCA channel switching) and performs the NPCA using the triggered channel access mode, wherein in the triggered channel access mode, the AP is allowed to initiate channel access in the NPCA primary channel of the BSS but the STA is not allowed to initiate channel access in the NPCA primary channel of the BSS. In an embodiment, the performing the NPCA using the triggered channel access mode comprises receiving a trigger frame from the AP in the NPCA primary channel of the BSS that solicits an uplink transmission and responsive to receiving the trigger frame, transmitting a frame to the AP in the NPCA primary channel of the BSS.

Otherwise, if the STA determines to use the untriggered channel access mode, the flow may move to operation 1830. At operation 1830, the STA may determine whether there is buffered data queued at the STA. If the STA determines that there is no buffered data queued at the STA, the flow may move to operation 1815, at which the STA remains on the primary channel of the BSS. Otherwise, if the STA determines that there is buffered data queued at the STA, the flow may move to operation 1835. At operation 1835, the AP switches from the primary channel of the BSS to a NPCA primary channel of the BSS (i.e., performs NPCA channel switching) and performs the NPCA using the untriggered channel access mode, wherein in the untriggered channel access mode, the AP and the STA are allowed to initiate channel access in the NPCA primary channel of the BSS. In an embodiment, the performing the NPCA using the untriggered channel access mode comprises transmitting a frame to the AP in the NPCA primary channel of the BSS without having received a trigger frame from the AP (without being solicited by the AP).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by an access point (AP) operating a basic service set (BSS) to decide whether to perform non-primary channel access (NPCA) channel switching, the method comprising:
responsive to detecting an overlapping basic service set (OBSS) transmission in a primary channel of the BSS, determining whether there is data to process between the AP and stations (STAs) associated with the AP; and
responsive to determining that there is data to process between the AP and the STAs, switching from the primary channel of the BSS to a NPCA primary channel of the BSS to perform the NPCA.

2. The method of claim 1, further comprising:
performing the NPCA by exchanging frames with at least one of the STAs in the NPCA primary channel of the BSS.

3. The method of claim 1, further comprising:
determining an amount of the data there is to process between the AP and the STAs; and
responsive to determining that the amount of the data there is to process between the AP and the STAs exceeds a threshold amount, performing the NPCA using a triggered channel access mode, wherein in the triggered channel access mode, the AP is allowed to initiate channel access in the NPCA primary channel of the BSS but the STAs are not allowed to initiate channel access in the NPCA primary channel of the BSS.

4. The method of claim 3, wherein the performing the NPCA comprises:
transmitting a trigger frame to at least one of the STAs in the NPCA primary channel of the BSS to solicit an uplink transmission.

5. The method of claim 3, further comprising:
transmitting a frame to the STAs that indicates that the STAs are to perform the NPCA using the triggered channel access mode.

6. The method of claim 1, further comprising:
determining an amount of the data there is to process between the AP and the STAs; and
responsive to determining that the amount of the data there is to process between the AP and the STAs does not exceed a threshold amount, performing the NPCA using an untriggered channel access mode, wherein in the untriggered channel access mode, the AP and the STAs are allowed to initiate channel access in the NPCA primary channel of the BSS.

7. The method of claim 6, further comprising:
transmitting a frame to the STAs that indicates that the STAs are to perform the NPCA using the untriggered channel access mode.

8. The method of claim 1, further comprising:
responsive to detecting a second OBSS transmission in the primary channel of the BSS, determining whether there is second data to process between the AP and the STAs; and
responsive to determining that there is no second data to process between the AP and the STAs, remaining on the primary channel of the BSS.

9. The method of claim 1, wherein the determining whether there is data to process between the AP and the STAs is based on traffic characteristic information exchanged with the STAs, wherein the traffic characteristic information includes one or more of: quality of service (QoS) information, stream classification service (SCS) information, and buffer status report (BSR) information.

10. A method performed by a station (STA) belonging to a basic service set (BSS) operated by an access point (AP) to decide whether to perform non-primary channel access (NPCA) channel switching, the method comprising:
responsive to detecting an overlapping basic service set (OBSS) transmission in a primary channel of the BSS, determining whether there is data to process between the AP and the STA; and
responsive to determining that there is data to process between the AP and the STA, switching from the primary channel of the BSS to a NPCA primary channel of the BSS to perform the NPCA.

11. The method of claim 10, further comprising:
performing the NPCA by exchanging frames with the AP in the NPCA primary channel of the BSS.

12. The method of claim 10, further comprising:
receiving a frame from the AP that indicates that the STA is to perform the NPCA using a triggered channel access mode, wherein in the triggered channel access mode, the AP is allowed to initiate channel access in the NPCA primary channel of the BSS but the STA is not allowed to initiate channel access in the NPCA primary channel of the BSS; and
performing the NPCA using the triggered channel access mode as a result of receiving the frame.

13. The method of claim 10, further comprising:
receiving a frame from the AP that indicates that the STA is to perform the NPCA using an untriggered channel access mode, wherein in the untriggered channel access mode, the AP and the STA are allowed to initiate channel access in the NPCA primary channel of the BSS; and
performing the NPCA using the untriggered channel access mode as a result of receiving the frame.

14. The method of claim 10, further comprising:
responsive to detecting a second OBSS transmission in the primary channel of the BSS, determining whether there is second data to process between the AP and the STA; and
responsive to determining that there is no second data to process between the AP and the STA, remaining on the primary channel of the BSS.

15. The method of claim 10, wherein the determining whether there is data to process between the AP and the STA is based on traffic characteristic information exchanged with the AP, wherein the traffic characteristic information includes one or more of: quality of service (QoS) information, stream classification service (SCS) information, and buffer status report (BSR) information.

16. A method performed by an access point (AP) operating a basic service set (BSS) to perform non-primary channel access (NPCA), the method comprising:
responsive to detecting an overlapping basic service set (OBSS) transmission in a primary channel of the BSS, determining an amount of buffered low latency data queued at the AP; and
responsive to determining that the amount of buffered low latency data queued at the AP exceeds a threshold amount, switching from the primary channel of the BSS to a NPCA primary channel of the BSS and performing NPCA in the NPCA primary channel of the BSS using a triggered channel access mode, wherein in the triggered channel access mode, the AP is allowed to initiate channel access in the NPCA primary channel of the BSS but STAs associated with the AP are not allowed to initiate channel access in the NPCA primary channel of the BSS.

17. The method of claim 16, wherein the performing the NPCA comprises:
transmitting a trigger frame to at least one of the STAs in the NPCA primary channel of the BSS to solicit an uplink transmission.

18. The method of claim 16, further comprising:
transmitting a frame to the STAs that indicates that the STAs are to perform the NPCA using the triggered channel access mode.

19. The method of claim 16, further comprising:
responsive to detecting a second OBSS transmission in the primary channel of the BSS, determining a second amount of buffered low latency data queued at the AP; and
responsive to determining that the second amount of buffered low latency data queued at the AP does not exceed the threshold amount, switching from the primary channel of the BSS to a NPCA primary channel of the BSS and performing NPCA in the NPCA primary channel of the BSS using an untriggered channel access mode, wherein in the untriggered channel access mode, the AP and STAs associated with the AP are allowed to initiate channel access in the NPCA primary channel of the BSS.

20. The method of claim 19, further comprising:
transmitting a frame to the STAs that indicates that the STAs are to perform the NPCA using the untriggered channel access mode.

21. A method performed by a station (STA) belonging to a basic service set (BSS) operated by an access point (AP) to determine whether to perform non-primary channel access (NPCA) channel switching, the method comprising:
receiving a frame from the AP that indicates that the STA is to perform the NPCA using a triggered channel access mode, wherein in the triggered channel access mode, the AP is allowed to initiate channel access in a NPCA primary channel of the BSS but the STA is not allowed to initiate channel access in the NPCA primary channel of the BSS; and
responsive to detecting an overlapping basic service set (OBSS) transmission in a primary channel of the BSS, switching from the primary channel of the BSS to the NPCA primary channel of the BSS and performing the NPCA in the NPCA primary channel of the BSS using the triggered channel access mode.

22. The method of claim 21, wherein the performing the NPCA comprises:
receiving a trigger frame from the AP in the NPCA primary channel of the BSS that solicits an uplink transmission; and
responsive to receiving the trigger frame, transmitting a frame to the AP in the NPCA primary channel of the BSS.

23. The method of claim 21, further comprising:
receiving a frame from the AP that indicates that the STA is to perform the NPCA using an untriggered channel access mode, wherein in the untriggered channel access mode, the AP and STA are allowed to initiate channel access in the NPCA primary channel of the BSS;
responsive to detecting a second OBSS transmission in the primary channel of the BSS, determining whether there is buffered data queued at the STA; and
responsive to determining that there is buffered data queued at the STA, switching from the primary channel of the BSS to the NPCA primary channel of the BSS and performing a second NPCA in the NPCA primary channel of the BSS using the untriggered channel access mode.

24. The method of claim 23, wherein the performing the second NPCA comprises:
transmitting a frame to the AP in the NPCA primary channel of the BSS without having received a trigger frame from the AP.

25. The method of claim 23, further comprising:
responsive to detecting a third OBSS transmission in the primary channel of the BSS, determining whether there is second buffered data queued at the STA; and
responsive to determining that there is no second buffered data queued at the STA, remaining on the primary channel of the BSS.

26. A wireless device configured to implement an access point (AP) that operates a basic service set (BSS), the wireless comprising:
a radio frequency transceiver;
a memory device storing a set of instructions; and
a processor coupled to the memory device, wherein the set of instructions, when executed by the processor, causes the AP to:
responsive to detecting an overlapping basic service set (OBSS) transmission in a primary channel of the BSS, determine whether there is data to process between the AP and stations (STAs) associated with the AP; and
responsive to determining that there is data to process between the AP and the STAs, switch from the primary channel of the BSS to a non-primary channel access (NPCA) primary channel of the BSS to perform NPCA.

27. A wireless device configured to implement a station (STA) that belongs to a basic service set (BSS) operated by an access point (AP), the wireless comprising:
a radio frequency transceiver;
a memory device storing a set of instructions; and
a processor coupled to the memory device, wherein the set of instructions, when executed by the processor, causes the STA to:
responsive to detecting an overlapping basic service set (OBSS) transmission in a primary channel of the BSS, determine whether there is data to process between the AP and the STA; and
responsive to determining that there is data to process between the AP and the STA, switch from the primary channel of the BSS to a non-primary channel access (NPCA) primary channel of the BSS to perform NPCA.
